(19) United States
(12) Patent Application Publication
(10) Pub. No.: US 2018/0127237 A1
(43) Pub. Date: May 10, 2018

(54) ACCESSIBLE ELEVATOR BUFFER

(71) Applicant: Otis Elevator Company, Farmington, CT (US)

(72) Inventors: Nicolas Fonteneau, Vitry Aux Loges (FR); Frederic Beauchaud, Coullons (FR); Emmanuel Convard, La Bussiere (FR)

(73) Assignee: Otis Elevator Company, Farmington, CT (US)

(21) Appl. No.: 15/564,250

(22) PCT Filed: Apr. 7, 2015
(86) PCT No.: PCT/IB2015/000619

§ 371 Date: Oct. 4, 2017

(51) Int. Cl. B66B 5/28; B66B 5/00

(52) U.S. Cl. CPC B66B 5/284; B66B 5/0062; B66B 5/288

(57) ABSTRACT

An accessible buffer assembly (200, 300, 400, 500, 600) for a buffer (202, 302, 402, 502, 602) of an elevator car (206, 306, 406, 506, 606) is provided. The assembly (200, 300, 400, 500, 600) includes an elevator car (206, 306, 406, 506, 606) having an access panel (104) and a buffer (202, 302, 402, 502, 602) movably attached to the elevator car (206, 306, 406, 506, 606) and configured to provide a safety feature to the elevator car (206, 306, 406, 506, 606). The buffer (202, 302, 402, 502, 602) is movable from a first position to a second position, the first position being a secured, operational position of the buffer to provide the safety feature, and the second position being an inspection position that is removed from the first position.

### BACKGROUND

The subject matter disclosed herein generally relates to buffers for elevators and, more particularly, to accessible buffers of an elevator car.

Traditional safety requirements for elevator shafts have led to larger spaces both at the top and bottom of the elevator shaft. However, such enlarged spaces may be disadvantageous for architectural reason. Thus, elevator lift manufacturers have attempted to reduce hoistway or elevator shaft overhead dimensions and pit depth while maintaining safety features. The two dimensions (overhead dimension and pit depth, also referred to collectively as safety volumes) are key characteristics for elevator construction and design. Mechanics currently go to the top of car, or on top thereof, or in the pit, for inspection or maintenance activity of various components of an elevator car. Thus, safety spaces or volumes are employed within the elevator shaft and thus require increased overhead and pit dimensions. The safety volumes of an elevator shaft may impact the dimensions and construction of a building that houses the elevator.

The required dimensions of the safety volumes on the top of the car and in the pit may be increased to provide safety to technicians located in either volume during maintenance, inspection, etc. Accordingly, the hoistway dimensions may be increased, which may not be desirable for overall building construction and design.

The dimensions in the pit may be provided for access to the underside of an elevator car to enable inspection and maintenance by a technician of various components installed thereon. Buffers are devices configured to soften the force with which an elevator runs into a pit of an elevator shaft during an emergency. Buffers may be located on the bottom of an elevator car or located within the pit of the elevator hoistway. The buffers installed in the hoistway may be spring buffers and/or oil buffers, or other types of buffers, which are installed in the pit of an elevator shaft. These buffers are fixed to the floor or surface of the pit and are configured to impact a bottom surface of an elevator car. Buffers installed on an elevator car are configured to reduce or minimize impacts during an emergency by impacting the floor or a surface of the pit of the elevator shaft. The buffers may require inspection and maintenance from time to time to ensure proper operation and ability to properly provide the safety mechanism.

### BRIEF DESCRIPTION

According to one embodiment an accessible buffer assembly for a buffer of an elevator car is provided. The assembly includes an elevator car having an access panel and a buffer movably attached to the elevator car and configured to provide a safety feature to the elevator car. The buffer is movable from a first position to a second position, the first position being a secured, operational position of the buffer to provide the safety feature, and the second position being an inspection position that is removed from the first position.

In addition to one or more of the features described above, or as an alternative, further embodiments may include a support configured to retain the buffer, the support providing the attachment between the buffer and the elevator car.

In addition to one or more of the features described above, or as an alternative, further embodiments may include the access panel of the elevator car enables access to the buffer from an interior of the elevator car.

In addition to one or more of the features described above, or as an alternative, further embodiments may include a release mechanism configured to enable disengagement of the buffer from the first position.

In addition to one or more of the features described above, or as an alternative, further embodiments may include the release mechanism is at least one of a lever, an actuator, a lock-pin, a spring-pin, a bolt, a lock, and a handle.

In addition to one or more of the features described above, or as an alternative, further embodiments may include an alignment mechanism configured to ensure alignment of the buffer in the first position.

In addition to one or more of the features described above, or as an alternative, further embodiments may include the alignment mechanism is at least one of a pin, a bolt, a screw, and a tab.

In addition to one or more of the features described above, or as an alternative, further embodiments may include the buffer is movable in one of a translation motion, a rotation motion, and a sliding motion.

In addition to one or more of the features described above, or as an alternative, further embodiments may include the buffer is detachable from the elevator car when in the second position.

In addition to one or more of the features described above, or as an alternative, further embodiments may include the elevator car further comprises a frame, wherein the buffer is movably attached to the frame of the elevator car.

According to another embodiment, a method of operating a buffer assembly of an elevator car is provided. The method includes accessing a buffer assembly of the elevator car from an interior of the elevator car; disengaging the buffer from a first position wherein the buffer is secured in an operational position; moving the buffer to a second position wherein the buffer is removed from the first position; moving the buffer back to the first position; and re-engaging the buffer in the first position.

In addition to one or more of the features described above, or as an alternative, further embodiments of the method may include disengaging the buffer comprises operating at least one of a release mechanism and an alignment mechanism.

In addition to one or more of the features described above, or as an alternative, further embodiments of the method may include the moving of the buffer from the first position to the second position and from the second position to the first position comprises at least one of a translation motion, a rotation motion, and a sliding motion.

In addition to one or more of the features described above, or as an alternative, further embodiments of the method may include opening an access panel of the elevator car prior to accessing the buffer assembly; and closing the access panel after re-engaging the buffer in the first position.

In addition to one or more of the features described above, or as an alternative, further embodiments of the method may include performing at least one of an inspection operation and a maintenance operation on the buffer when the buffer is in the second position.

Technical effects of embodiments of the present disclosure include buffers of an elevator car that are configured to be easily accessible. Further technical effects include a movable buffer for an elevator car, and methods of moving a buffer of an elevator car between operational and maintenance positions.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a perspective schematic illustration of an elevator car in accordance with an exemplary embodiment of the present disclosure;

FIG. 2A is a schematic illustration of an accessible buffer in a first position in accordance with an exemplary embodiment of the present disclosure;

FIG. 2B is a schematic illustration of the accessible buffer of FIG. 2A in an intermediate position;

FIG. 2C is a schematic illustration of the accessible buffer of FIG. 2A in a second position;

FIG. 3A is a schematic illustration of an alternative exemplary embodiment of an accessible buffer of the present disclosure in a first position;

FIG. 3B is a schematic illustration of the accessible buffer of FIG. 3A in an intermediate position;

FIG. 3C is a schematic illustration of the accessible buffer of FIG. 3A in a second position;

FIG. 4A is a schematic illustration of another alternative exemplary embodiment of an accessible buffer of the present disclosure in a first position;

FIG. 4B is a schematic illustration of an underside view of the accessible buffer of FIG. 4A;

FIG. 4C is a schematic illustration of the accessible buffer of FIG. 4A indicating the motion toward a second position;

FIG. 5A is a schematic illustration of another alternative exemplary embodiment of an accessible buffer of the present disclosure in a first position;

FIG. 5B is a schematic illustration of the accessible buffer of FIG. 5A indicating the motion toward a second position;

FIG. 5C is a schematic illustration of the accessible buffer of FIG. 5A in the second position;

FIG. 6A is a schematic illustration of another alternative exemplary embodiment of an accessible buffer of the present disclosure in a first position;

FIG. 6B is a schematic illustration of the accessible buffer of FIG. 6A in an intermediate position;

FIG. 6C is a schematic illustration of the accessible buffer of FIG. 6A in a second position; and

FIG. 7 is a process for operating an accessible buffer in accordance with an exemplary embodiment of the present disclosure.

### DETAILED DESCRIPTION

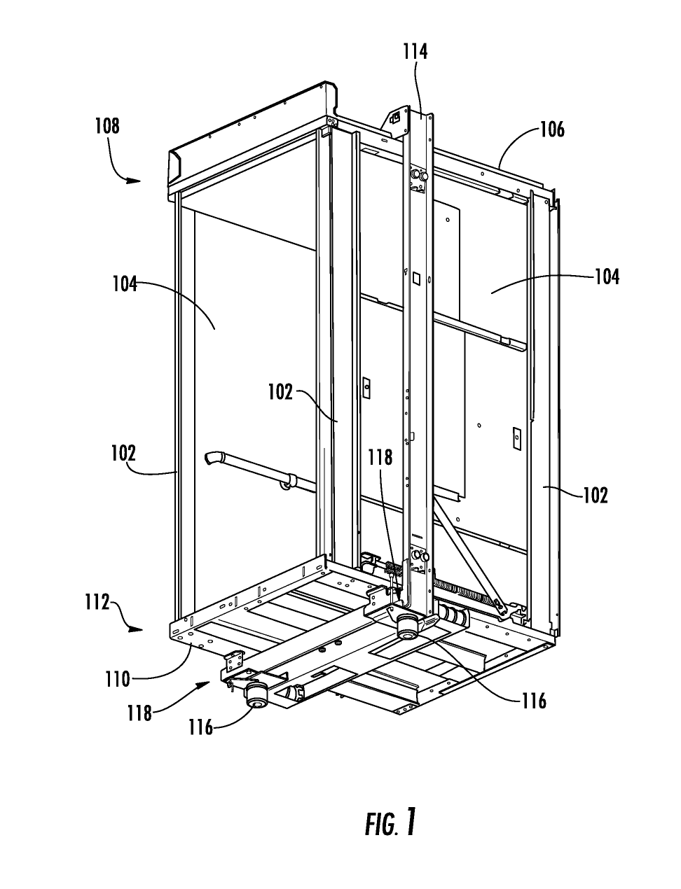

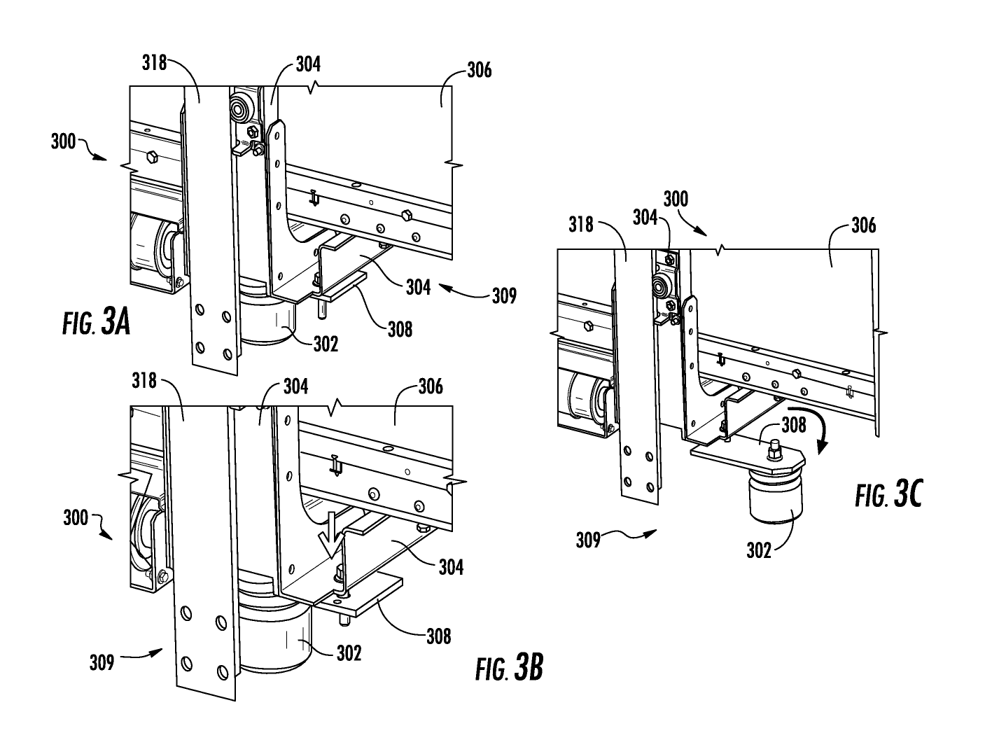

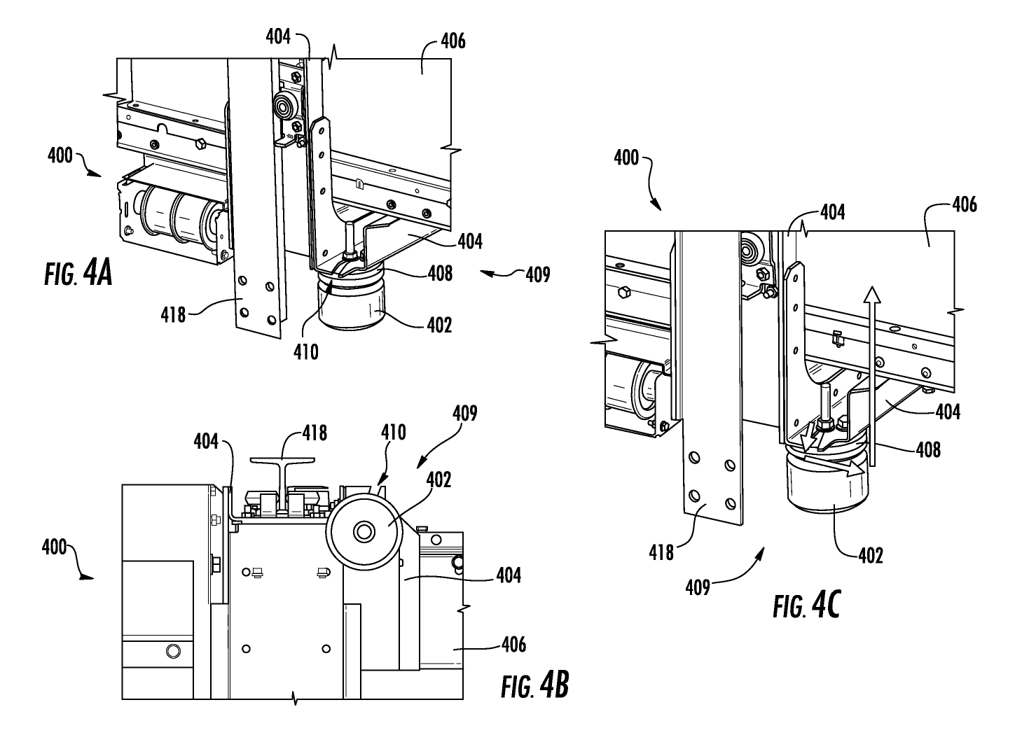

With reference to FIG. 1, a schematic view of an elevator car 100 in accordance with an exemplary embodiment of the present disclosure is shown. Elevator car 100 includes a frame having vertical supports 102 with panels 104 disposed therebetween, a ceiling 106 at a top 108 of the elevator car 100, and a floor 110 at a bottom 112 of the elevator car 100. The frame of the elevator car 100 may also include an optional frame portion 114 that is configured on the exterior of the elevator car 100 and is configured to enable the elevator car 100 to move within an elevator shaft and along a guide rail of the elevator shaft, as shown, for example, in FIGS. 3A-3C and 4A-4C.

On the bottom 112 of the frame portion 114 one or more buffers 116 are disposed. The buffers 116 are configured to soften the impact with which the elevator car 100 may run into a pit of an elevator shaft during an emergency. The buffers 116 installed on the elevator car 100 may be configured to reduce or minimize the impact during an emergency by impacting and absorbing the impact of the elevator car 100 with a floor or bottom of a pit of an elevator shaft. Those of skill in the art will appreciate that the frame portion 114 is optional, and the buffers 116 may be attached directly to the elevator car 100 or to another element of the elevator car 100. Thus, the depicted configuration of the buffers attached to the elevator car is not considered to be limiting, but rather is presented for explanatory and illustrative purposes only.

The buffers 116 are installed on or configured as part of an access mechanism 118 that is configured to move between a first position and a second position, as described herein. In the first position, the buffer 116 is in an operational position. The operational position is a locked or secure position that is configured to enable the safety feature provided by the buffer 116. In the second position, the buffer 116 is in a maintenance position, wherein a mechanic can access the buffer 116 for inspection, maintenance, etc. The access mechanism 118 thus enables the buffer 116 to be movable, translatable, rotatable, etc. between the first position and the second position.

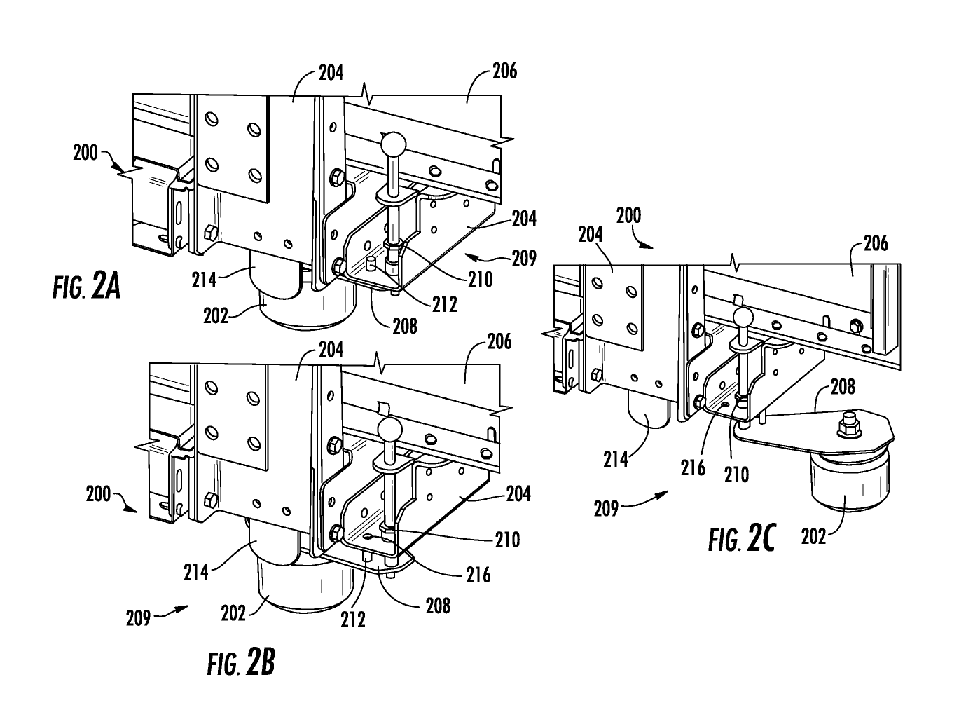

Turning now to FIGS. 2A-2C, an exemplary embodiment of a buffer assembly 200 in accordance with the present disclosure is shown. Buffer assembly 200 includes a buffer 202 that is installed on the bottom of a frame portion 204 of an elevator car 206, similar to that shown in FIG. 1. In alternative embodiments, the buffers may be installed or configured directly on the elevator car, or attached to another element of the elevator car. As shown in FIGS. 2A-2C, the buffer 202 is attached to a support 208 which is part of the access mechanism 209. The access mechanism 209 includes a release mechanism 210 and an alignment mechanism 212 that are attached to the support 208. The support 208 is movable such that the buffer 202 may be moved from a first position (FIG. 2A) to a second position (FIG. 2C) and back.

The release mechanism 210 may be configured as a lever, actuator, lock-pin, spring-pin, bolt, handle, lock, or other type of releasable mechanism or actuatable mechanism. The release mechanism 210 is configured to secure or lock the buffer 202 in the first position, and is releasable or actuable to allow the buffer 202 to move to the second position. The alignment mechanism 212 is configured to align and/or secure the support 208, and thus the buffer 202, in the first position. The alignment mechanism 212 may be a pin, bolt, screw, tab, etc. or other type of aligning mechanism. The buffer assembly 200 also includes a stop 214 that is configured to assist in the positioning and/or locking of the buffer 202 in the first position.

As noted, FIG. 2A shows the buffer 202 in the first position. In the first position, the buffer 202 is securely attached or fixed to the frame portion 204 and thus the elevator car 206 such that it can provide the safety feature of a buffer, as known in the art. The release mechanism 210 and alignment mechanism 212 are in positions or states such that the buffer 202 is prevented from moving away from the first position.

To access the buffer 202 for inspection or maintenance, a technician, mechanic, or other person (“user”) may gain access from within or inside the elevator car 206. For example, a user may open a panel, elevator wall, or portion of an elevator wall or panel to open the side of the elevator and obtain access to the buffer assembly 200. In some embodiments, for example with reference again to FIG. 1, a side panel 104 may be moved inward into the elevator car 100, thus opening the side thereof. In other embodiments, a portion of a side panel or wall may be accessible or openable to grant or permit access to the buffer assembly 200 that is attached to the bottom of the elevator car 206.

Turning now to FIG. 2B, the release mechanism 210 is operated such that the alignment mechanism 212 is moved out of engagement or alignment, thus enabling movement of the buffer 202 away from the first position. In this embodiment, as show in FIG. 2B, the release mechanism 210 is pushed downward, and the support 208 moves downward accordingly. At the same time, the alignment mechanism 212 is also moved downward, and out of engagement, for example out of engagement with an aperture 216.

In accordance with embodiments of the present disclosure, when a user desires access to the buffer 202 for inspection, maintenance, or other purpose, there is no need for the user to enter the pit of an elevator shaft and/or to be physically located below the elevator car 206. Because the buffer assembly 200, and buffer 202, is accessible from the inside of the elevator car 206, there is little to no risk imposed on the user.

After operation of the release mechanism 210, the buffer 202, attached to the support 208, may be moved to the second position (FIG. 2C). As shown in FIG. 2C, the buffer 202 is easily reachable and there is no obstruction to inspecting buffer 202. Further, if necessary, it may be simple to remove, replace, and/or perform maintenance on buffer 202 or other parts of the buffer assembly 200 from within the elevator car 206 when the buffer is in the second position.

After performing an inspection or maintenance operation, the user may then move the buffer 202 and support 208 back to the first position (FIG. 2A). During the return movement, the support 208 may contact the stop 214 such that the user knows that the support 208 and the buffer 202 are located properly in the first position. The release mechanism 210 may then be operated to lock or secure the buffer 202 in the first position, and the alignment mechanism 212 may slide within the aperture 216 to align and prevent movement of the buffer 202.

Turning now to FIGS. 3A-3C, an alternative exemplary embodiment of a buffer assembly in accordance with the present disclosure is shown. The buffer assembly 300 is similar to the buffer assembly 200 of FIGS. 2A-2C and thus like features are labeled with like reference numbers, except preceded by a “3” rather than a “2.”

The buffer assembly 300 includes a buffer 302 and a support 308. The buffer 302 is movably connected to a frame portion 304 of the elevator car 306. The buffer assembly 300 includes a release mechanism that enables the buffer 302 to be locked in a first position (FIG. 3A) and moveable to a second position (FIG. 3C), with an intermediate view shown in FIG. 3B. In the embodiment of FIGS. 3A-3C, a guide rail 318 of an elevator shaft operates as a stop to ensure the buffer 302 is locked into the first position during an operational mode and/or after the buffer 302 is in the second position. As shown in FIG. 3B, the support 308 is pushed downward, as indicated by the arrow in FIG. 3B, which enables the buffer 302 to be moved from the first position to the second position.

Turning now to FIGS. 4A-4C, an alternative exemplary embodiment of a buffer assembly in accordance with the present disclosure is shown. The buffer assembly 400 is similar to the buffer assembly 200 of FIGS. 2A-2C and thus like features are labeled with like reference numbers, except preceded by a “4” rather than a “2.” FIG. 4B is a bottom view of the buffer assembly 400.

The buffer assembly 400 includes a buffer 402 and a support 408. The buffer 402 is movably connected to a frame portion 404 of the elevator car 406. The buffer assembly 400 includes a release mechanism 410 that enables the buffer 402 to be locked in a first position (FIG. 4A) and moveable to a second position (FIG. 4C, indicated by the arrows). A bottom view of the buffer assembly 400 is shown in FIG. 4B. In the embodiment of FIGS. 4A-4C, the release mechanism 410 is configured as a channel or slot that enables removal of the buffer 402 from the frame portion 404, as indicated by the arrows of FIG. 4C.

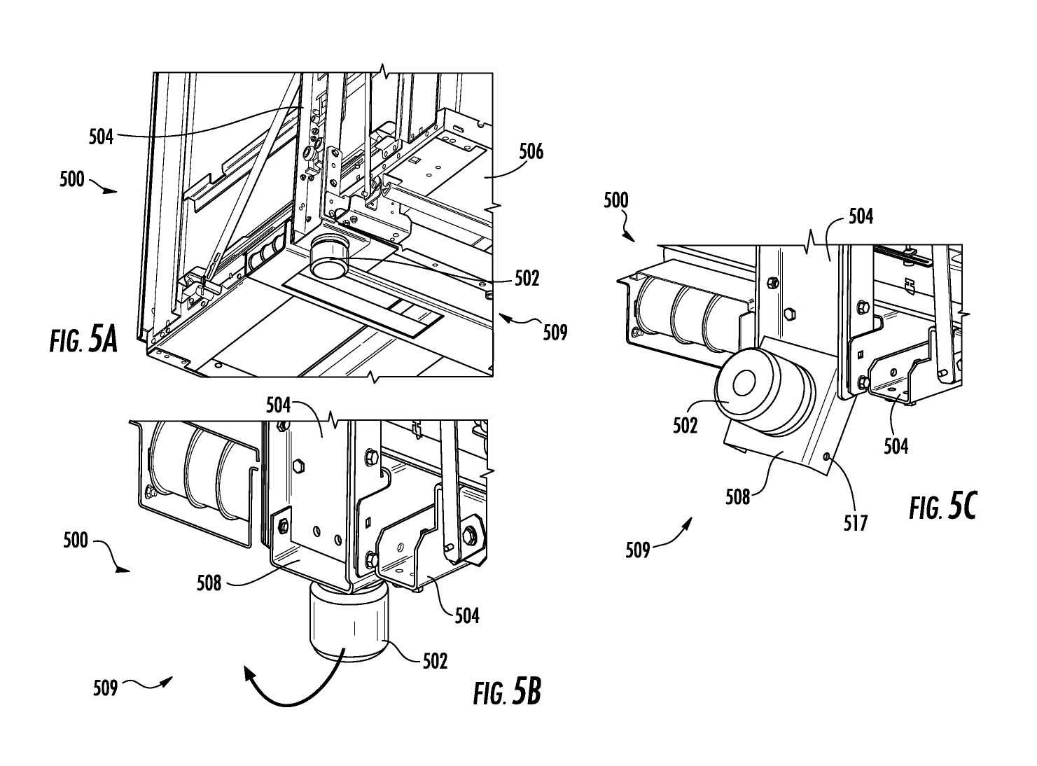

Turning now to FIGS. 5A-5C, an alternative exemplary embodiment of a buffer assembly in accordance with the present disclosure is shown. The buffer assembly 500 is similar to the buffer assembly 200 of FIGS. 2A-2C and thus like features are labeled with like reference numbers, except preceded by a “5” rather than a “2.”

The buffer assembly 500 includes a buffer 502 and a support 508. The buffer 502 is movably connected to a frame portion 504 of the elevator car 506. The buffer assembly 500 includes a release mechanism that enables the buffer 502 to be locked in a first position (FIG. 5A) and moveable to a second position (FIG. 5C). In the embodiment of FIGS. 5A-5C, the release mechanism is configured as a pin-and-aperture configured to enable lock and release of the buffer 502 relative to the frame portion 504. Movement of the buffer 502 from the first position to the second position is indicated by the arrow of FIG. 5B. A pin may pass through a portion of the support 508, such as at aperture 517, shown in FIG. 5C. As is apparent from FIGS. 5A-5C, the buffer assembly 500 is hinged such that it may rotate or swing as shown in FIGS. 5B and 5C.

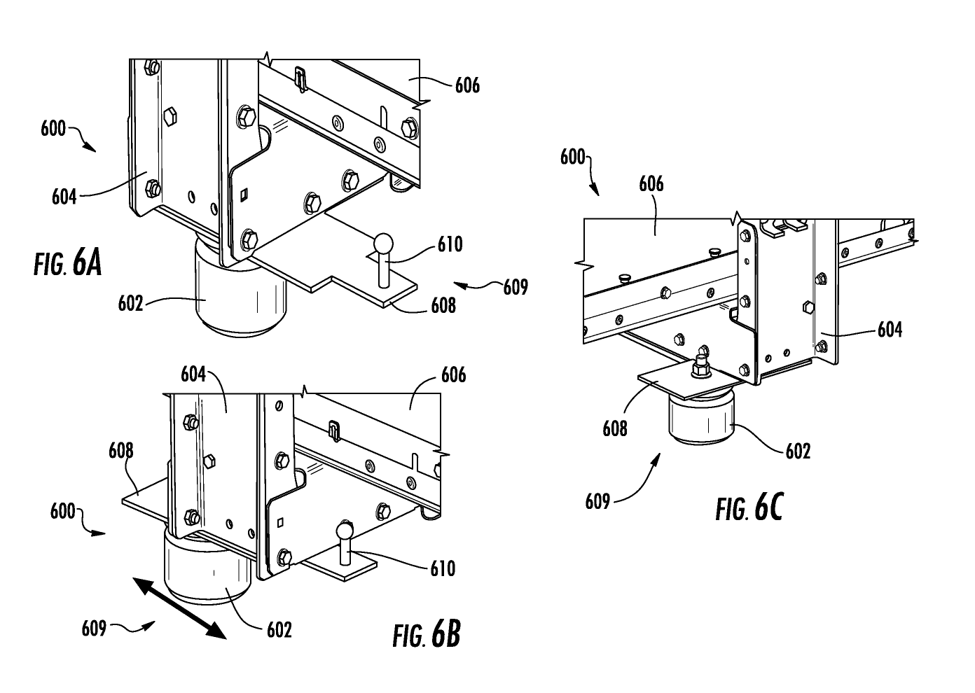

Turning now to FIGS. 6A-6C, an alternative exemplary embodiment of a buffer assembly in accordance with the present disclosure is shown. The buffer assembly 600 is similar to the buffer assembly 200 of FIGS. 2A-2C and thus like features are labeled with like reference numbers, except preceded by a “6” rather than a “2.”

The buffer assembly 600 includes a buffer 602 and a support 608. The buffer 602 is movably connected to a frame portion 604 of the elevator car 606. The buffer assembly 600 includes a release mechanism 610 that enables the buffer 602 to be locked in a first position (FIG. 6A) and moveable between the first position and a second position (FIG. 6C, indicated by the arrow shown in FIG. 6B). In the embodiment of FIGS. 6A-6C, the release mechanism 610 is configured similar to the release mechanism 210 of FIGS. 2A-2C.

As will be appreciated by those of skill in the art, the embodiments shown and described above are merely exemplary and variations and changes may be made without departing from the scope of the present disclosure. In each embodiment, the buffer is able to be moved from a first position, where the buffer is locked and/or secured to provide a safety feature, to a second position, where the buffer may be inspected, repaired, removed, etc.

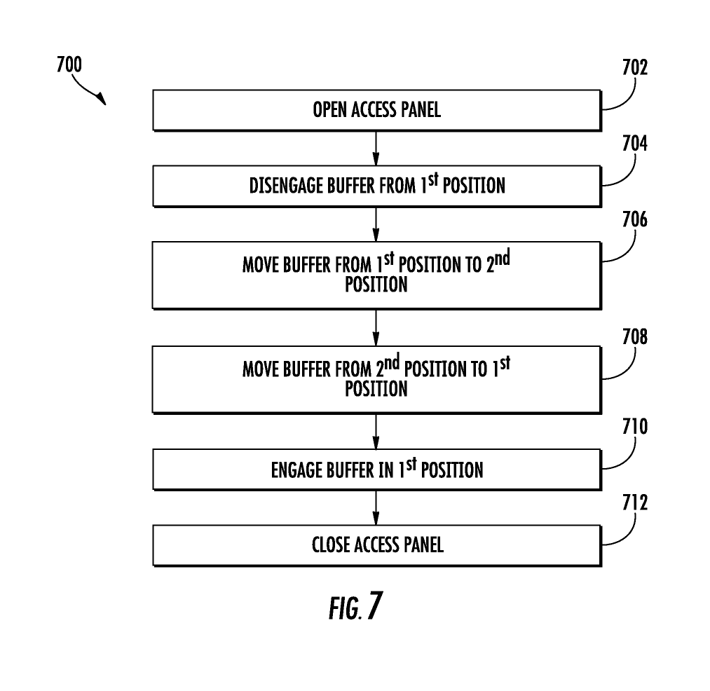

Turning now to FIG. 7, a process 700 for operating a buffer assembly in accordance with an exemplary embodiment of the present disclosure is shown. The process 700 enables a user to inspect or perform maintenance on a buffer of an elevator car from inside the elevator car. Thus, in accordance with process 700, a user does not need to enter the pit of an elevator shaft and be subject to risks associated therewith.

At step 702 a user may open an access panel of the elevator car. The access panel may be an entire side wall of the elevator car or may be a portion thereof. With the access panel removed or opened, the user may then disengage a buffer from a first position at step 704. For example, step 704 may include unlocking the buffer from the elevator car, such as by disengaging a lock-pin or employing some other release mechanism. After disengaging the buffer from the first position at step 704, the user may then move the buffer at step 706 to a second position. The second position may be a position that enables inspection or maintenance to be performed on the buffer. Subsequently, the user may then move the buffer from the second position back to the first position at step 708. The user may the engage, secure, and/or lock the buffer in the first position at step 710, such that the buffer is securely fixed to the elevator car and is capable of performing the safety function of a buffer during operation of the elevator car. Finally, the user may replace or close the access panel at step 712.

Advantageously, embodiments of the present disclosure provide an accessible buffer of an elevator car that is configured to prevent a user from needing to enter a pit of an elevator shaft in order to perform an inspection or maintenance of the buffer or replace the buffer. Further, advantageously, embodiments of the present disclosure enable a user to access the buffer from the inside of an elevator car.

While the present disclosure has been described in detail in connection with only a limited number of embodiments, it should be readily understood that the present disclosure is not limited to such disclosed embodiments. Rather, embodiments of the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

For example, although a limited number of embodiments and configurations are shown and described herein; variations on the type of assemblies and systems may be made without departing from the scope of the present disclosure. For example, the release and securing mechanisms may be altered without deviating from the scope of the present disclosure. Furthermore, the mounting and/or attachment of the buffer to the elevator car, as part of the accessible buffer assembly may be varied without departing from the scope of the present disclosure.

Accordingly, the present disclosure is not to be seen as limited by the foregoing description, but is only limited by the scope of the appended claims.

1. An accessible buffer assembly for a buffer of an elevator car, the assembly comprising:
an elevator car having an access panel; and
a buffer movably attached to the elevator car and configured to provide a safety feature to the elevator car,
wherein the buffer is movable from a first position to a second position, the first position being a secured, operational position of the buffer to provide the safety feature, and the second position being an inspection position that is removed from the first position.

2. The buffer assembly of claim 1, further comprising a support configured to retain the buffer, the support providing the attachment between the buffer and the elevator car.

3. The buffer assembly of claim 1, wherein the access panel of the elevator car enables access to the buffer from an interior of the elevator car.

4. The buffer assembly of claim 1, further comprising a release mechanism configured to enable disengagement of the buffer from the first position.

5. The buffer assembly of claim 4, wherein the release mechanism is at least one of a lever, an actuator, a lock-pin, a spring-pin, a bolt, a lock, and a handle.

6. The buffer assembly of claim 1, further comprising an alignment mechanism configured to ensure alignment of the buffer in the first position.

7. The buffer assembly of claim 6, wherein the alignment mechanism is at least one of a pin, a bolt, a screw, and a tab.

8. The buffer assembly of claim 1, wherein the buffer is movable in one of a translation motion, a rotation motion, and a sliding motion.

9. The buffer assembly of claim 1, wherein the buffer is detachable from the elevator car when in the second position.

10. The buffer assembly of claim 1, wherein the elevator car further comprises a frame, wherein the buffer is movably attached to the frame of the elevator car.

11. A method of operating a buffer assembly of an elevator car, the method comprising:
accessing a buffer assembly of the elevator car from an interior of the elevator car;
disengaging the buffer from a first position wherein the buffer is secured in an operational position;
moving the buffer to a second position wherein the buffer is removed from the first position;
moving the buffer back to the first position; and
re-engaging the buffer in the first position.

12. The method of claim 11, wherein disengaging the buffer comprises operating at least one of a release mechanism and an alignment mechanism.

13. The method of claim 11, wherein the moving of the buffer from the first position to the second position and from the second position to the first position comprises at least one of a translation motion, a rotation motion, and a sliding motion.

14. The method of claim 11, further comprising:
opening an access panel of the elevator car prior to accessing the buffer assembly; and
closing the access panel after re-engaging the buffer in the first position.

15. The method of claim 11, further comprising performing at least one of an inspection operation and a maintenance operation on the buffer when the buffer is in the second position.

16. The method of claim 11, further comprising detaching the buffer from the elevator car when the buffer is in the second position.

17. The method of claim 11, wherein a support is configured to retain the buffer, the support providing an attachment between the buffer and the elevator car.

18. The method of claim 12, wherein the alignment mechanism is at least one of a pin, a bolt, a screw, and a tab.

19. The method of claim 12, wherein the release mechanism is at least one of a lever, an actuator, a lock-pin, a spring-pin, a bolt, a lock, and a handle.
